(19) United States
(12) Patent Application Publication
(10) Pub. No.: US 2007/0289102 A1
(43) Pub. Date: Dec. 20, 2007

(54) Detachable beverage container handle

(76) Inventors: Shuki Kazaz, New York, NY (US); Scott D. Nelson, New York, NY (US)

Correspondence Address: PEARL COHEN ZEDEK LATZER, LLP, 1500 BROADWAY 12TH FLOOR, NEW YORK, NY, 10036, US

(21) Appl. No.: 11/454,138

(22) Filed: Jun. 16, 2006

(51) Int. Cl. A47J 45/07

(52) U.S. Cl. 16/425

(57) ABSTRACT

This invention relates to a detachable beverage container handle, specifically the invention relates to a reusable figurine-shaped handle, which can be mounted and released from a plurality of beverage container diameters.

### FIELD OF INVENTION

This invention is directed to a detachable beverage container handle, specifically the invention relates to a reusable figurine-shaped handle, which can be mounted and released from a plurality of beverage container diameters.

### BACKGROUND OF THE INVENTION

Numerous types of beverages are sold in cans or cups that are similar in shape and design but which vary in other aspects, such as diameter, particularly top rim diameter, among various can manufacturers.

Throughout their history, the beverage industry, in cooperation with the can manufacturers, have experimented with various can sizes for packaging soft drinks, beer, and the like. The cans have varied in such ways as volume (12 ounces and 16 ounces, e.g.), as well as height, body and top circumference, etc. Although various can sizes have been tried throughout the years, presently the beverage industry has three primary can sizes, most commonly referred to, and differentiated by, the can top diameter. The can top diameters most commonly utilized today are the 202, which has a can top diameter (the outside diameter of the rim at the top of the can) of approximately 2⅛ inches; the 204, which has a can top diameter of approximately 2¼ inches; and the 206, which has a can top diameter of approximately 2⅜ inches. These cans are typically constructed of aluminum, are most often sealed by an upstanding rim at the top end of the can, with the rim forming a seam along the outer circumference of the top, and provide means disposed upon the can top to manually open the can in order for the contents to be consumed directly out of the beverage can. Unless the drinker takes the intermediate step of transferring the liquid into another drinking container, the liquid contents within the container cabot be consumed without the drinker coming into direct oral contact with the can.

Similarly, conventional single-serve beverages are available at quick serve restaurants or concession stands in various event venues in cups small enough to be held with one hand. As the popularity of multi-serve food packages increases, however, the demand for multi-serve beverages also increases. The cups which hold large quantities of fluid, e.g. 64 oz., are difficult for most individuals to grasp with one hand.

To date, singular application attachments of fixed configuration were made to apply to a plurality of beverage container diameters only through the manufacturing of multiple embodiments of detachable drinking attachments, each having a different diameter and/or span. This approach to the problem adds to the cost of manufacturing in the form of producing and inventorying a variety of attachment sizes, as well as for the end user in the form of multiple purchases if he or she wanted to have a detachable drinking attachment regardless of the beverage top diameter. Even if these obstacles were not an issue with the manufacturer or end user there would still remain the disadvantage of having to store and/or transport a variety of attachments.

In addition, due to condensation accumulation on the outer walls of the beverage container resulting from cold beverages, or the heat of hot beverage containers; other consumers of beverages such as children, the elderly, and the disabled, may have difficulty grasping a can or many of the beverage containers because their grips may be too weak or their grip is too small relative to the circumference of each beverage container.

### SUMMARY OF THE INVENTION

In one embodiment, the invention provides a detachable handle for a container having a base and a wall connected to the base wherein the wall has a rim comprising a first coupling means for detachably connecting to said base; a second coupling disposed from said first coupling means for detachably connecting to said wall; and a figure disposed therebetween.

In another embodiment, the invention provides a detachable handle for a container having a base and a wall connected to the base wherein the wall has a rim comprising a first coupling means for detachably connecting to said base; a second coupling disposed from said first coupling means for detachably connecting to said wall; and a figure disposed therebetween, adapted to be coupled, at different times, with the tops of a first and second container to direct liquid from each of said beverage containers to a drinker's mouth, the top of said first container having a first annular rim defining a first diameter, the top of said second beverage container having a second annular rim defining a second diameter, wherein said first annular rim of said first beverage container is different in diameter from said second annular rim of said second beverage container.

In one embodiment, the invention provides a detachable handle for a container having a base and a wall connected to the base wherein the wall has a rim comprising a first coupling means for detachably connecting to said wall; a second coupling disposed from said first coupling means for detachably connecting to said base; and a figure disposed therebetween.

### BRIEF DESCRIPTION OF THE DRAWINGS

FIG. 1. shows an embodiment of the humaniform-shaped handle (1) disposed between the first coupling means (2) and the second coupling means (3), attached to extremities of the humaniform (4), wherein the extremities are capable of being restrictively adjusted by hinges (5), and where the coupling means are attached to the top rim (71) of the wall (7) having a D1 diameter and a bottom base (72) having a D2 diameter.

FIG. 2 shows an embodiment of a side view of the figurine shaped handle, where the hinges (5) are adjustable to accommodate a smaller sized beverage container (7), attached thereto with the first coupling means (2) having a C-shape configuration (21) defining an opening capable of incorporating the rim (71) and the second coupling means (3) having a configuration (31) capable of attaching to the base of container (7).

### DETAILED DESCRIPTION OF THE INVENTION

This invention relates in one embodiment to detachable and reusable handle for a container, such as a beverage container in certain embodiments.

In one embodiment, the invention provides a detachable handle for a container having a base and a wall connected to the base wherein the wall has a rim comprising a first coupling means for detachably connecting to said base; a second coupling disposed from said first coupling means for detachably connecting to said wall; and a figure disposed therebetween.

In another embodiment, the invention provides a container comprising a detachable handle for a container having a base and a wall connected to the base wherein the wall has a rim, comprising a first coupling means for detachably connecting to said base; a second coupling disposed from said first coupling means for detachably connecting to said wall; and a figure disposed therebetween, or a detachable handle for a container having a base and a wall connected to the base wherein the wall has a rim, comprising: a first coupling means for detachably connecting to said wall; a second coupling disposed from said first coupling means for detachably connecting to said base; and a figure disposed therebetween.

In one embodiment, the invention provides a detachable handle for a container having a base (72) and a wall connected to the base wherein the wall has a rim (71), comprising: a first coupling means (2) for detachably connecting to said wall; a second coupling (3) disposed from said first coupling means for detachably connecting to said base (72); and a figure (1) disposed therebetween.

In another embodiment, the container to which the detachable handle described herein is coupled is a beverage container.

Conventional single-serve beverages are available at quick serve restaurants, as well as public events, in cups small enough to be held with one hand. As the popularity of multi-serve food packages increases, however, the demand for multi-serve beverages also increases. The cups which hold large quantities of fluid, e.g. 64 oz., are difficult for most individuals to grasp with one hand. In one embodiment, the detachable container handle described herein is adjusted to accommodate these large cups to facilitate carrying the cups. In another embodiment, the handle (1) described herein, is detachably attached to a rim (71) of the cup.

In one embodiment, the first coupling means (2) used in the detachable handle (1), which is capable of detachably attaching to the top rim (71) of the wall (7) of the beverage container. In another embodiment, the beverage container is a cup or a can., having a rim (71) diameter (D1) and a base diameter (D2).

In one embodiment, the invention provides a detachable handle (1), having first coupling means (2) being molded of resilient material comprising a C-clamp (21), wherein the C-clamp (21) defines an opening capable of incorporating therein the top rim (71) of the beverage container. In one embodiment, the first (2) and second (3) coupling means are made of plastic or resilient metal in another embodiment. In one embodiment, the first detachable coupling means (2) is made such that when it is attached to the container, axial movement of the container is substantially prevented.

In one embodiment, the second coupling means (3), used in the detachable handle (1) described herein, is made of a resilient material, comprises a substantially flat member (31), wherein said member is curved toward the base of said container, in a way that through tension created by attaching the second coupling means (3) to the base of the container (72), the container (7) is stabilized against the first coupling means (2).

A person skilled in the art would recognize that through the use of hinges (5) disposed on the joints of the figurine's (1) extremities (4), the user could adjust the span defined between the first (2) and second (3) coupling means, thereby accommodating a larger or smaller container.

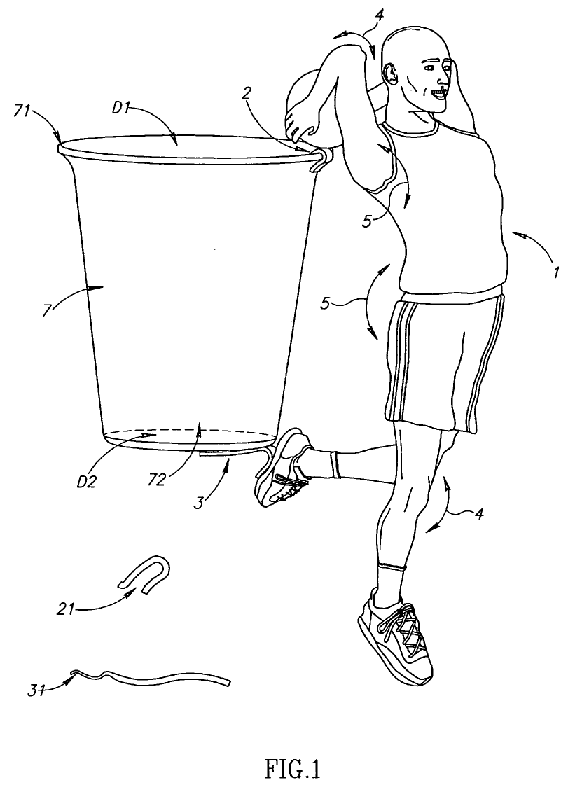

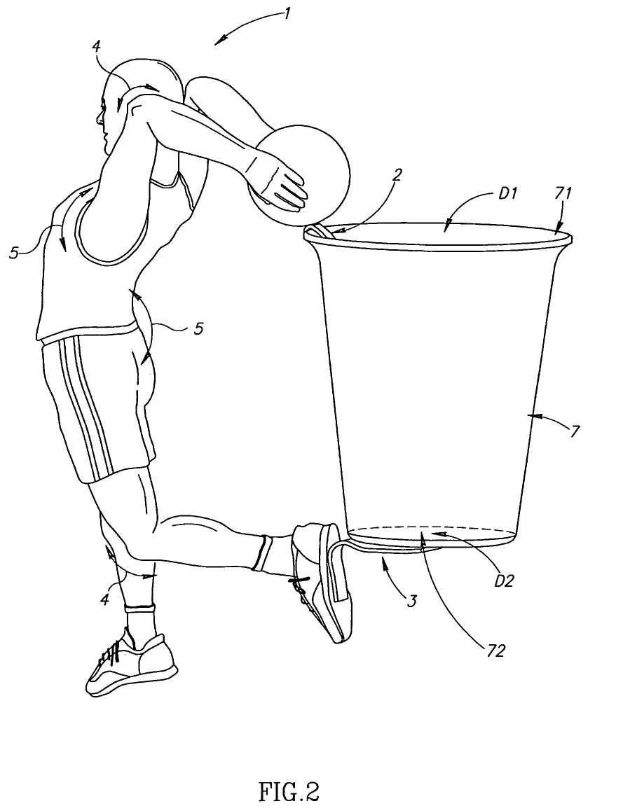

Referring now to FIGS. 1 and 2 of the drawings, an adjustable hinge assembly 5 can be seen having an upper arm element and a lower arm element extending there from, both comprised of suitable material. The upper arm element may be adjustably secured within a recess of a lower arm engagement plate, by multiple fasteners. In another embodiment, the adjustable hinge assembly (5) is connected between the second coupling means (3) and the figurine (1) for permitting the second coupling means to be pivoted as a unit between a closed position in relation to the figurine, as illustrated in FIG. 1, and an open position, for a lrger container, allowing the same figurine to be used for a plurality of container dimensions.

In one embodiment, the adjustable hinge (5) comprises a thumb screw capable of locking the hinge at the desired position. In another embodiment, the thumb screw is molded of the same material that the figurine (1) is made of.

Having described preferred embodiments of the invention with reference to the accompanying drawings, it is to be understood that the invention is not limited to the precise embodiments, and that various changes and modifications may be effected therein by those skilled in the art without departing from the scope or spirit of the invention as defined in the appended claims.

What is claimed is:

1. A detachable handle for a container having a base and a wall connected to the base wherein the wall has a rim, comprising:
a. a first coupling means for detachably connecting to said base;
b. a second coupling disposed from said first coupling means for detachably connecting to said wall; and
c. a figure disposed therebetween

2. The detachable handle of claim 1, wherein the container is a beverage container.

3. The detachable handle of claim 2, wherein said first coupling means capable of detachably attaching to the top rim of the wall of the beverage container.

4. The detachable handle of claim 2, wherein said beverage container is a cup or a can.

5. The detachable handle of claim 1, wherein said first coupling means being molded of resilient material comprising a C-clamp, wherein the C-clamp defines an opening capable of incorporating therein the top rim of the beverage container.

6. The detachable handle of claim 5, wherein said C-clamp is capable of substantially preventing or inhibiting axial rotation of the beverage container when coupled to said beverage container.

7. The detachable handle of claim 1, wherein said second coupling means being a resilient material, comprises a substantially flat member, wherein said member is curved toward the base of said container.

8. The detachable handle of claim 1, wherein the figure is a humaniform or an animal form

9. The detachable handle of claim 8, wherein said first and second coupling means are operably attached to an integral extremity of said humaniform or animal form.

10. The detachable handle of claim 8, wherein said first and second coupling means are operably attached to an article attached to said humaniform or animal form.

11. The detachable handle of claim 8, wherein said humanifirm or animal form has adjustable extremities, allowing detachably coupling onto varying sizes of said container.

12. The detachable handle of claim 11, wherein the adjustable extremities are hingedly attached to a body of said humaniform or animal form.

13. The detachable handle of claim 12, wherein the adjustable extremities are capable of being restricted in motion following adjustment.

14. The detachable handle of claim 8, wherein the humaniform or animal form is an athlete, an actor, a cartoon character, a celebrity, a mammal or a politician.

15. The detachable handle of claim 10, wherein said article is a bat, a ball, a racquet, a book, a skull or a tool.

16. A container comprising the detachable handle of claim 1.

17. The detachable handle of claim 1, adapted to be coupled, at different times, with the tops of a first and second container to direct liquid from each of said beverage containers to a drinker's mouth, the top of said first container having a first annular rim defining a first diameter, the top of said second beverage container having a second annular rim defining a second diameter, wherein said first annular rim of said first beverage container is different in diameter from said second annular rim of said second beverage container.

18. A detachable handle for a container having a base and a wall connected to the base wherein the wall has a rim, comprising:
a. a first coupling means for detachably connecting to said wall;
b. a second coupling disposed from said first coupling means for detachably connecting to said base; and
c. a figure disposed therebetween

19. The detachable handle of claim 18, wherein the container is a beverage container.

20. The detachable handle of claim 19, wherein said first coupling means capable of detachably attaching to the top rim of the wall of the beverage container.

21. The detachable handle of claim 19, wherein said beverage container is a cup or a can.

22. The detachable handle of claim 18, wherein said first coupling means being molded of resilient material comprising a C-clamp, wherein the C-clamp defines an opening capable of incorporating therein the top rim of the beverage container.

23. The detachable handle of claim 22, wherein said C-clamp is capable of substantially preventing or inhibiting axial rotation of the beverage container when coupled to said beverage container.

24. The detachable handle of claim 18, wherein said second coupling means being a resilient material, comprises a substantially flat member, wherein said member is curved toward the base of said container
